(19) United States
(12) Patent Application Publication
(10) Pub. No.: US 2021/0230846 A1
(43) Pub. Date: Jul. 29, 2021

(54) Atmospheric Water Generator Utilizing Centrifugal Hydraulic Air Compressor

(71) Applicant: Rocky Lee Rawls, (US)

(72) Inventor: Rocky Lee Rawls, Gautier, MS (US)

(73) Assignee: Rocky Lee Rawls, Gautier, MS (US)

(21) Appl. No.: 17/156,627

(22) Filed: Jan. 24, 2021

Related U.S. Application Data
(60) Provisional application No. 62/965,787, filed on Jan. 24, 2020.

(30) Foreign Application Priority Data
Jan. 24, 2020 (US) 62965787

(51) Int. Cl. E03B 3/28; C02F 1/04; C02F 1/38; B01D 5/00

(52) U.S. Cl. CPC E03B 3/28; B01D 5/0039; C02F 1/38; C02F 1/041

(57) ABSTRACT

An atmospheric water generator utilizing centrifugal hydraulic air compressor is for harvesting water from the atmosphere. The purpose of atmospheric water generator utilizing centrifugal hydraulic air compressor is to provide potable water. The atmospheric generator utilizing centrifugal hydraulic air compressor includes a housing having a reservoir, a plurality of centrifugal discs, drive components, water pump, heat exchangers, and air filters. The housing reservoir further includes an indication device to determine the water level in device. The centrifugal discs can utilize centripetal forces to hydraulically compress the air, with water, to harvest the water from the atmosphere. The drive components further comprise a hollow shaft to direct the water to the centrifugal discs. In addition, the shape of the centrifugal disc utilizes the compressed air and water exiting the discs to help rotate the discs.

### CROSS REFERENCE TO RELATED APPLICATION

This application claims the benefit of U.S. Provisional Application No. 62/965,787 filed on Jan. 24, 2020. The above identified patent application is herein incorporated by reference in its entirety to provide continuity of disclosure.

### BACKGROUND OF THE INVENTION

The present invention relates to atmospheric water generator devices. More specifically, the present invention relates to an atmospheric water generator that utilizes centrifugal disc to hydraulically raise the pressure of the air to harvest water from the air.

Many attempts have been made to provide an atmospheric water generator that harvest water from the atmosphere. These devices offer drinking water in areas that the atmosphere is present. Atmospheric water generators are commonly used by anyone around the world that needs drinking water. Typically, these devices produce fresh drinking water from the atmosphere in a variety of different ways: absorption, adsorption, condensation, and air compression technologies. Atmospheric water generators have a multitude of different issues associated with the different ways of producing water. Some of the issues are that atmospheric water generators use a lot of energy, are bulky, need different costly water sorbents, the water sorbents require constant changing, costly reverse osmosis filters to filter the adsorbent from the water, require a desorption cycle which shortens its efficiency, and only generate water in high humidity conditions.

Atmospheric water generators are used as a device to supply fresh drinking water. These known devices, however, may be difficult to utilize do to cost, maintenance issues, and energy requirements. For example, a person wanting to harvest water from the atmosphere would have to use considerable energy resources to run the device and expend time and maintenance cost to replace the reverse osmosis filtration system.

U.S. Pat. No. 10,683,644B2 to Kim, et al, describes a sorption-based atmospheric water harvesting device. However, Kim, et al, has several known drawbacks. In particular is the Metal Organic Frameworks utilized in the adsorption of the water. The Metal Organic Framework used is costly to develop and synthesize. The present invention utilizes the hydrogen bonding of water to adsorb the water from the atmosphere. Further the Metal Organic Framework requires a reverse osmosis filtration system to insure the potability of the water. The present invention eliminates this costly need of water filtration since water does not have to be filtered from water. Further, sorption-based technologies require a specific sorption-desorption cycle. These cycles are usually based on day/night cycles to utilize thermal differences in these cycles. The present invention can harvest continually with no specific cycles increasing productivity and efficiency compared to the prior art. Further sorption-based technologies require the use of a fan to bring the air through the sorbent which utilizes energy and increases costs. The present invention utilizes the effect of water being forced through a tube to scavenge air into the system eliminating the need for a fan to force air into the system.

U.S. Pat. No. 20040040322A1 to Engel and Clasby, describes a vapor compression-based water vapor condensing unit. However, Engel and Clasby, has several known drawbacks. In particular, the system utilizes a vapor compression system that uses considerable electricity to operate. The present invention utilizes nozzles directed around the circumference of the centrifugal hydraulic disc to help return a portion of the energy required to spin the disc.

In light of the devices disclosed in the prior art, it is submitted that the present invention substantially diverges in design elements from the prior art and consequently is clear that there is a need in the art for an improvement to existing atmospheric water generator devices. In this regard the instant invention substantially fulfills these needs.

### SUMMARY OF THE INVENTION

In view of the foregoing disadvantages inherent in the known types of atmospheric water generators now present in the prior art, the present invention provides an atmospheric water generator wherein the same can be utilized for producing potable drinking water from the atmosphere.

It is therefore an object of the present invention to provide a new and improved atmospheric water generator that has all of the advantages of the prior art and none of the disadvantages.

The present invention relates to atmospheric water generator comprising a housing having a reservoir, centrifugal discs, drive unit, water pump, and a plurality of components to accomplish the direction of air flow.

It is therefore an object of the present invention to have a hollow drive shaft connected to the drive motor to supply the centrifugal disc with water. This will allow the disc to utilize water for the hydraulic component.

It is therefore an object of the present invention to utilize water as a sorbent and hydraulic component of the machine reducing costs.

It is an object of the present invention to utilize a centrifugal disc to turn water into the hydraulic component.

It is an object of the present invention to use the dehydrated air exiting the discs as a way to cool down the water-ambient air heat exchangers further decreasing costs and complexity of the system.

It is another object of the present invention to use water as a thermal transfer medium to transfer the heat from one section of the device to the other. This will allow great efficiencies than a second system for heat transfer.

It is another object of the present invention uses the water to absorb the heat of compression of air which will allow thermal management of the device.

Other objects, features and advantages of the present invention will become apparent from the following detailed description taken in conjunction with the accompanying drawings.

### BRIEF DESCRIPTION OF THE DRAWINGS

FIG. 1 shows a perspective view of one embodiment of the present invention.

FIG. 2 shows a front view of one embodiment of the present invention.

FIG. 3 shows a back view of one embodiment of the present invention.

FIG. 4 shows an internal component view of one embodiment of the present invention.

FIG. 5 shows an internal component view of one embodiment of the present invention.

FIG. 6 shows a top view of one embodiment of the present invention.

FIG. 7 shows a bottom view of one embodiment of the present invention.

FIG. 8 shows a component view of one embodiment of the present invention.

FIG. 9 shows a component view of one embodiment of the present invention.

FIG. 10 shows a flowchart of an embodiment of method of the present invention.

### DETAILED DESCRIPTIONS OF THE INVENTION

Reference is made herein to the attached drawings. Like reference numerals are used throughout the drawings to depict like or similar elements of the atmospheric water generator utilizing centrifugal hydraulic air compressor. For the purposes of presenting a brief and clear description of the present invention, the preferred embodiment will be discussed as used for harvesting drinking water from the atmosphere. The figures are intended for representative purposes only and should not be considered to be limiting in 20 any respect.

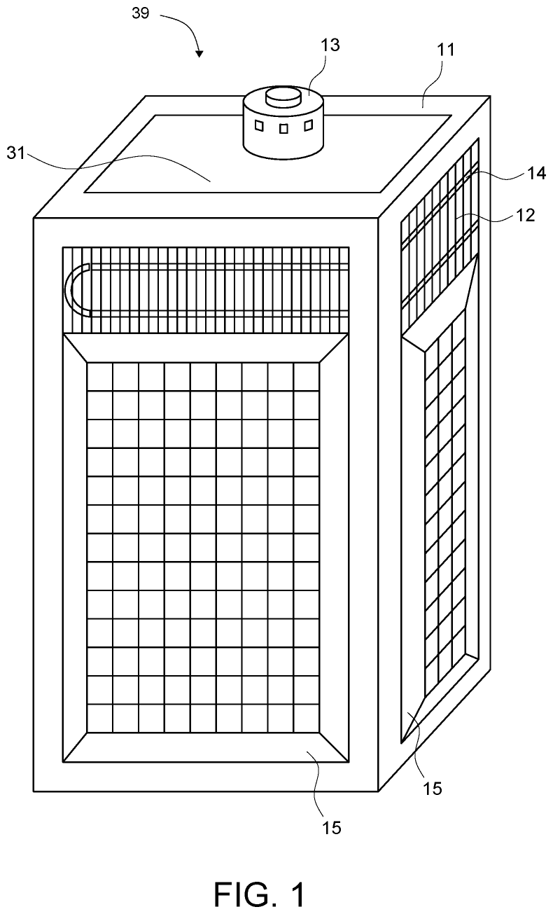

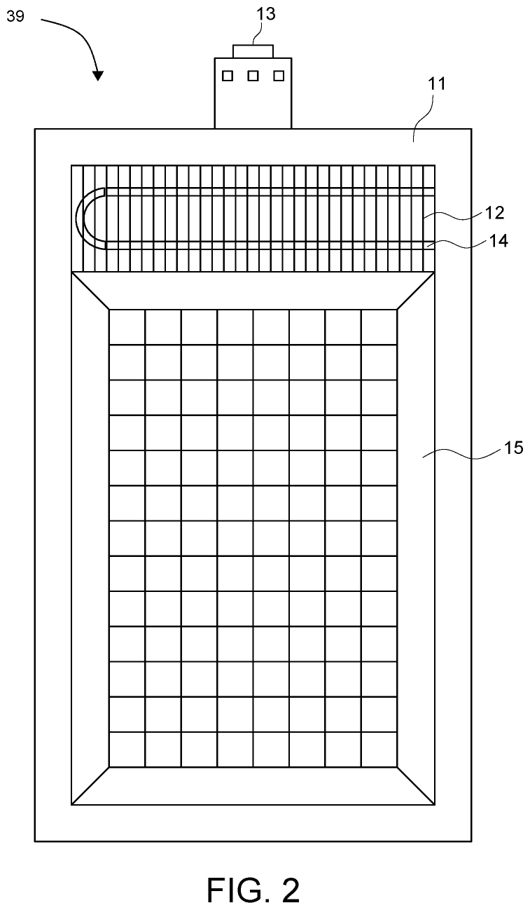

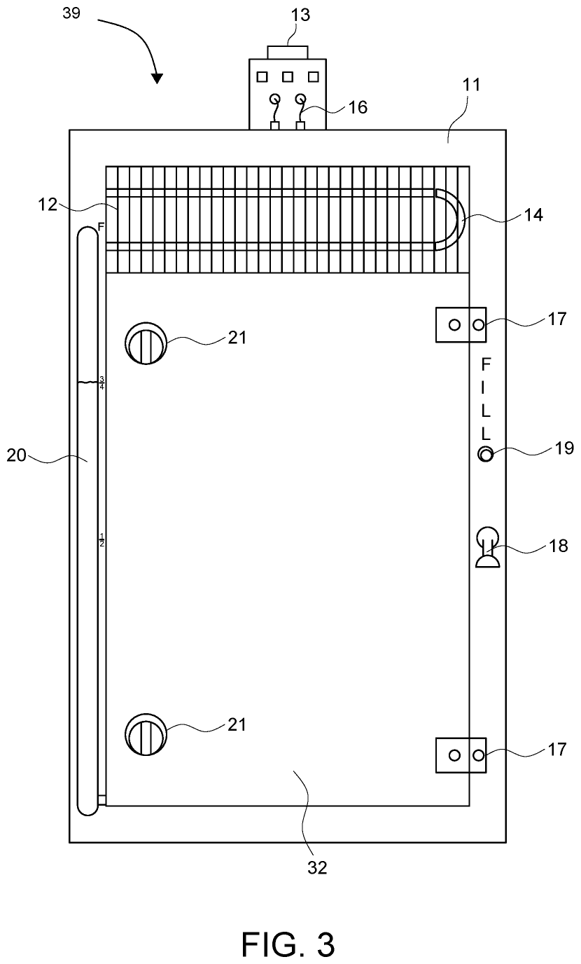

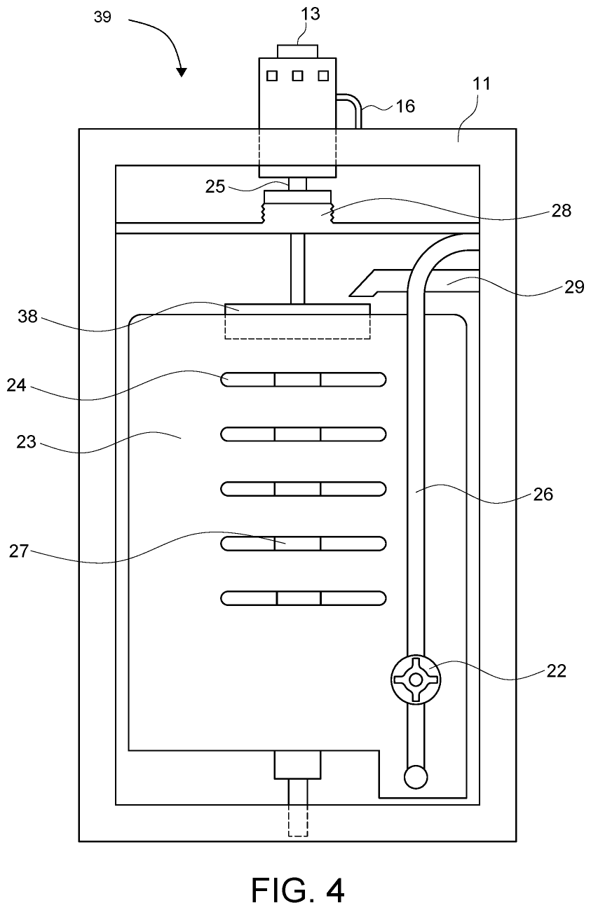

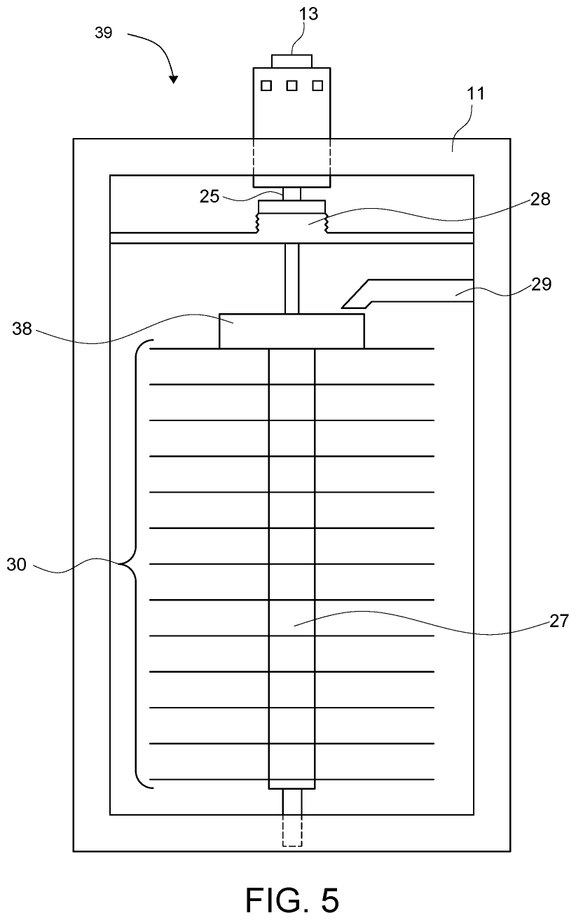

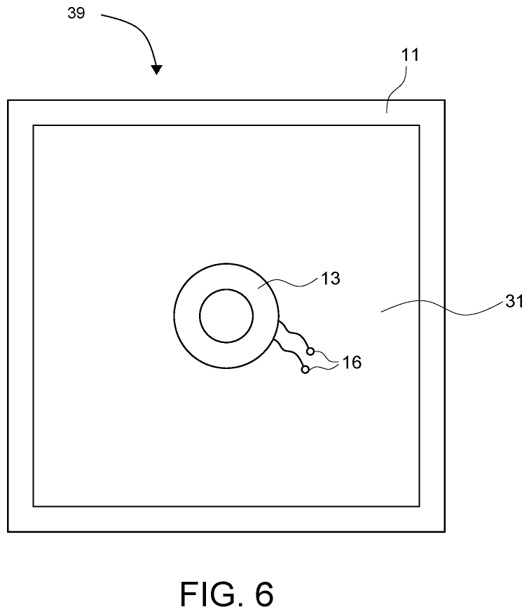

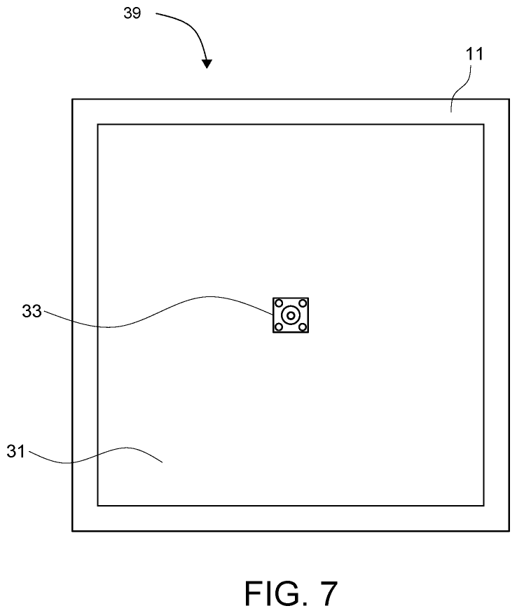

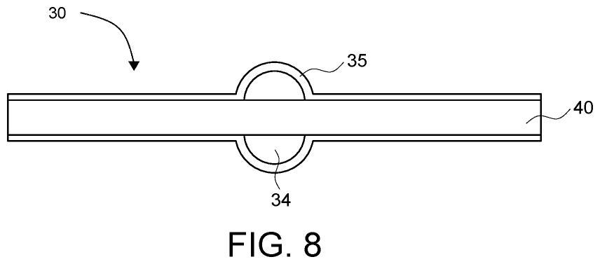

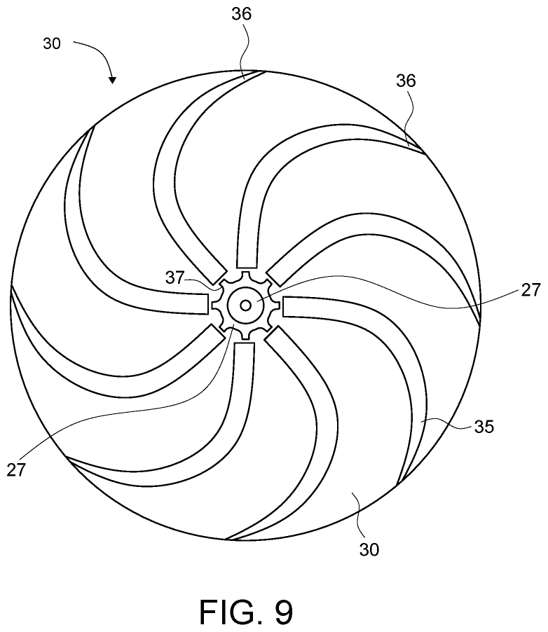

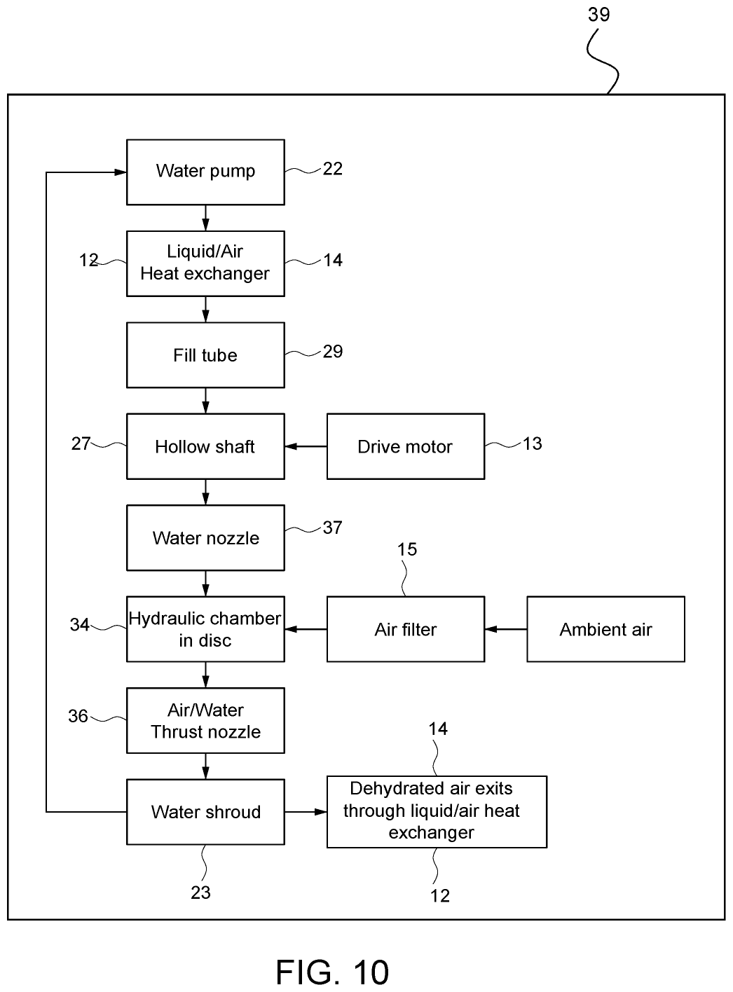

Referring now to FIGS. 1 and 2, there is a perspective view of one embodiment of the present invention and a front end view of one embodiment of the present invention, respectively. The present invention provides an atmospheric water generator utilizing centrifugal hydraulic air compressor 39 comprising a hollow frame 11 housing air filters 15 liquid-air heat exchanger water passage 14 metal fins 12 drive motor 13 and panel 31. The hollow frame 11 holds all the components in a rigid fashion. In one embodiment of the present invention, the atmospheric water generator utilizing centrifugal hydraulic air compressor can have a non-rigid shape with the body being comprised of inflatable panels for compactness and portability. The drive motor 13 is positioned in the middle of the panel 31 wherein the panel 31 performs as an air dam. In one embodiment of the present invention, the drive motor 13 can be located on the bottom of the present invention. The liquid-air heat exchanger water passage 14 metal fins 12 are positioned above the air filter 15. In one embodiment of the present invention, the liquid-air heat exchanger water passage 14 metal fins 12 can be positioned in panel 31 wherein the drive motor 13 will benefit from extra thermal management. In the shown embodiment, the hollow frame 11 has a square shape with rectangular cross sectional area. However, the hollow frame 11 can have any suitable shape. In the shown embodiment, the air filter 15 has a rectangular shape with square filter holding apparatus. However, the air filter 15 can have any suitable shape with or without the filter holding apparatus. In the shown embodiment, the drive motor 13 has a tubular shape with round cross sectional area. However, the drive motor 13 can have any suitable shape. In the shown embodiment, the drive motor 13 is an electrical drive motor. However, the drive motor 13 can be any kind of motor. In another embodiment of the present invention, the drive motor 13 can be a fossil fuel based motor for off grid water generation. Referring now to FIG. 3, there is a back view of one embodiment of the present invention. The present invention provides an atmospheric water generator utilizing centrifugal hydraulic air compressor 39 comprises a hollow frame 11 metal fins 12 drive motor 13 liquid-air heat exchanger water passage 14 drive motor electrical connections 16 access door brackets 17 extracted water nozzle 18 hydraulic water fill port 19 extracted water reservoir indicator 20 access door latch 21 access door 32 wherein the user can access the internal components of the present invention. The drive motor electrical connections 16 attach to drive motor 13 and panel 31. In the shown embodiment, the drive motor electrical connections 16 are attached to the panel 31 and the drive motor 13. However, the drive motor electrical connections 16 can attach to any source of power. In another embodiment of the present invention, the drive motor electrical connections 16 attach to the drive motor 13 and solar panels. In the shown embodiment, the hydraulic water fill port 19 has a circular shape with a fill port hole. However, the hydraulic water fill port 19 can have any suitable shape. In the shown embodiment, access door latch 21 access door bracket 17 access door 32 comprise the access point to the internal structure of the present invention. In the shown embodiment, the access door 32 has a rectangular shape. However, the access door 32 can have any suitable shape. In another embodiment of the present invention, the access door 32 is left out with an air filter 15 taking place of the access door 32. The extracted water reservoir indicator 20 is connected to the hollow frame 11 and serves as a visual indicator of the extracted water of the present invention. In the shown embodiment, the extracted water reservoir indicator 20 has a tubular shape with round transparent cross sectional area. However, the extracted water reservoir indicator 20 can have any suitable shape and opacity. In another embodiment of the present invention, the extracted water reservoir indicator 20 can be left off for the use of a digital display or other suitable means. The extracted water nozzle 18 is attached to the hollow frame 11. The extracted water nozzle 18 can be attached to any point on the hollow frame 11 to facilitate in the emptying of the water reservoir. In the shown embodiment, the extracted water nozzle 18 has a tubular shape with round cross sectional body. However, the extracted water nozzle 18 can have any suitable shape. In another embodiment of the present invention, the extracted water nozzle 18 can be replaced with a water pump to facilitate in the emptying of the hollow frame 11. Referring now to FIGS. 4 and 5, there is an internal view of one embodiment of the present invention and a internal view minus the water shroud 23 of one embodiment of the present invention, respectively. The present invention provides atmospheric water generator utilizing centrifugal hydraulic air compressor 39 comprises hollow frame 11 holds the top bearing upper support 28 the drive motor 13 shaft 25 hollow shaft water funnel 38 hollow shaft 27 centrifugal discs 30 wherein comprises the centrifugal portion of the present invention. In the shown embodiment, the top bearing upper support 28 has a cross member and bearing assembly. However, the top bearing support 28 can have any suitable shape, support structure, or bearing. In the shown embodiment, the centrifugal discs 30 are plural. However, the centrifugal discs 20 can have any suitable number of discs. The water shroud 23 water pump 22 water tube to liquid-air heat exchanger 26 hollow frame 11 liquid-air heat exchanger water passage 14 hollow shaft fill tube 29 comprises the water circulation and heat transfer components of the present invention. Filtered air holes 24 water shroud 23 comprise the air inlet portion of one embodiment of the present invention. In the shown embodiment, the filtered air holes 24 has a slit shape. However, the filtered air holes 24 can have any suitable shape. The present invention includes other water passages (not shown for clarity) to facilitate in the transfer of the water from one component to another. In another embodiment of the present invention, the water shroud 23 is shaped to not require the use of the filtered air holes 24. In the shown embodiment, the hollow shaft water funnel 38 has a round shape with a funnel opening. However, the hollow shaft water funnel 38 can have any suitable shape to direct water into the hollow shaft 27. In another embodiment of the present invention, the hollow shaft water funnel 38 is connected to hollow shaft fill tube 29 by a rotary water seal. Referring now to FIG. 6, there is a top view of one embodiment of the present invention. The present invention provides atmospheric water generator utilizing centrifugal hydraulic compressor 39 comprises hollow frame 11 drive motor 13 positioned in the middle of the panel 31 wherein the drive motor electrical connections 6 pass through the panel 31 to a power source. In referring to FIGS. 1-6, The present invention provides an atmospheric water generator utilizing centrifugal hydraulic air compressor 39 shows panel 31 located above the top bearing support 28. However, the top bearing support 28 can be made to support the panel 31. Referring now to FIG. 7, there is a bottom view of one embodiment of the present invention. The present invention provides an atmospheric water generator utilizing centrifugal hydraulic air compressor 39 comprises a hollow frame 11 panel 31 with a lower bearing 33 and shaft 25 centrally positioned. In the shown embodiment, the lower bearing 33 is a generic bearing to hold the shaft. However, the lower bearing 33 can be any bearing suitable to holding the shaft 25. In another embodiment of the present invention, the lower bearing 33 is eliminated and relies on the top bearing support 28 to dampen vibrations. Referring now to FIGS. 8 and 9, there is a component view of one embodiment of the present invention and a component view of one embodiment of the present invention, respectively. The present invention provides an atmospheric water generator utilizing centrifugal hydraulic air compressor 39 comprising of a centrifugal disc 30 wherein the disc support 40 formed metal structure 35 forms the hydraulic chamber 34 which flows through to the air-water thrust nozzles 36 due to centrifugal force and the hollow shaft 27 shaft 25 and water nozzles 37 form the water distribution network to the hydraulic chamber 34. In the shown embodiment, the air-water thrust nozzles 36 are tapered to make more thrust. However, the air-water thrust nozzles 36 may have any suitable shape. In the shown embodiment, the formed metal structure 35 is metal. However, the formed metal structure 35 may be made of any suitable material. In the shown embodiment, the disc support 40 is made of metal. However, the disc support 40 may be made of any suitable material. In another embodiment of the present invention, the disc support 40 is eliminated and just utilizes the formed metal structure 35 to form the hydraulic chamber 34. In the shown embodiment, the centrifugal disc 30 have multiple hydraulic chambers 34. However, the centrifugal disc 30 can have any number of hydraulic chambers 34 suitable to making the atmospheric water generator utilizing central hydraulic air compressor 39 to harvest water from the atmosphere. In another embodiment of the present invention, the centrifugal discs 30 can be attached at the peripheral of the centrifugal disc 30 to strengthen the centrifugal disc 30. In another embodiment of the present invention, the centrifugal discs 30 have a shroud on the periphery of the centrifugal discs 30 to facilitate the airflow to the liquid-air heat exchanger 14 and metal fins 12. Referring now to FIG. 10, there is shown a flowchart of one embodiment of the present invention. In the shown embodiment of a method of the present invention, the atmospheric water generator utilizing centrifugal hydraulic air compressor 39 utilizes a hydraulic system to compress air to harvest water from the atmosphere. The present invention includes a power source (not shown) to spin the drive motor 3 and drive the water pump 22. The present invention includes controls and wiring (not shown) to control the speed of the drive motor 3 and the water pump 22. The controls (not shown) send power from the power source (not shown) to the drive motor 3 and water pump 22. The drive motor 3 spins the shaft 25 which is connected to the hollow shaft 27 water nozzle 37 hydraulic chamber 34 air-water thrust nozzle 36 which is stabilized by the top support bearing 28 and lower bearing 33. The water pump 22 pumps water from the bottom of the water shroud 23 to the liquid-air heat exchanger passage 14 where any heat is exchanged with the ambient air via the metal fins 12 to the hollow shaft fill tube 29. The hollow shaft fill tube 29 sends water to the hollow shaft 27 via the hollow shaft water funnel 38. The hollow shaft 27 sends water to the water nozzle 37 where the water enters the hydraulic chamber 34 in the centrifugal disc 30. The action of the water being slung through the hydraulic chamber 34 creates negative pressure in the internal compartment of the atmospheric water generator utilizing centrifugal hydraulic air compressor 39 pulls ambient air through the air filter 15 which passes through the filtered air holes 24 in the water shroud 23 where the air mixes with the water inside the hydraulic chamber 34. The hydraulic chamber 34 sends airwater mixture by centrifugal effect to the air-water thrust nozzles 36 which lets the air-water mixture spray unto the water shroud 23. From the water shroud 23 the water falls due to gravity to the bottom of the water shroud 23 where it is picked up by the water pump 22 to repeat the cycle. From the water shroud 23 the dehydrated air leaves and passes through the metal fins 12 and liquid-air heat exchanger water tube 14 before passing out of the atmospheric water generator utilizing centrifugal hydraulic air compressor 39. In one embodiment of the present invention, the speed control of the centrifugal discs 30 determine the amount of water harvested from the atmosphere. In another embodiment of the present invention, the atmospheric water generator utilizing centrifugal hydraulic air compressor 39 can be utilized to dehydrate air for food, home, 10 commercial or industrial useage.

Although the invention has been explained in relation to its preferred embodiment, it is to be understood that many other possible modifications and variations can be made without departing from the spirit and scope of the invention.

I claim:

1) An atmospheric water generator utilizing centrifugal hydraulic air compressor comprising:
a hollow frame with panels, drive motor, water pump, liquid-air heat exchanger passage, metal fins, air filters, water nozzle, centrifugal discs, hydraulic chamber, air-water thrust nozzles, hollow shaft, water shroud, wherein the device is configured into a centrifugal hydraulic air compressor that utilizes water to compress air to extract water from the atmosphere.

2) The atmospheric water generator utilizing centrifugal hydraulic air compressor of claim 1, wherein: one or more air filters disposed on the surface to filter incoming air.

3) The atmospheric water generator utilizing centrifugal hydraulic air compressor of claim 1, wherein: one or more centrifugal discs attached to the hollow shaft to hydraulically compress the air.

4) The atmospheric water generator utilizing centrifugal hydraulic air compressor of claim 1, wherein: one or more liquid-air heat exchange devices to exchange heat to the surrounding atmosphere.

5) The atmospheric water generator utilizing centrifugal hydraulic air compressor of claim 1, wherein: one or more drive motors disposed on the hollow frame to drive the centrifugal discs.

6) The atmospheric water generator utilizing centrifugal hydraulic air compressor of claim 1, wherein: a drive motor to spin the centrifugal components operated electrically.

7) The atmospheric water generator utilizing centrifugal hydraulic air compressor of claim 1, wherein: a drive motor to spin the centrifugal components operated by fossil fuels.

8) The atmospheric water generator utilizing centrifugal hydraulic air compressor of claim 1, wherein: a power source to drive the electrical components.

9) The atmospheric water generator utilizing centrifugal hydraulic air compressor of claim 1, wherein: the hollow frame contains the harvested water until useage.

10) The atmospheric water generator utilizing centrifugal hydraulic air compressor of claim 1, wherein: the drive motor is connected to a shaft, hollow shaft, hollow shaft water funnel, water nozzles, centrifugal discs, hydraulic chambers, air-water thrust nozzles.

11) The atmospheric water generator utilizing centrifugal hydraulic air compressor of claim 1, wherein: the centrifugal disc contains one or more water nozzles, hydraulic chambers, air-water thrust nozzles.

12) The atmospheric water generator utilizing centrifugal hydraulic air compressor of claim 1, wherein: the water component is the heat transfer vehicle for thermal management.

13) The atmospheric water generator utilizing centrifugal hydraulic air compressor of claim 1, wherein: the dehydrated air is used to cool off the water in the liquid-air heat exchangers.

14) A method of harvesting water from the atmosphere, comprising the steps of: utilizing a centrifuge to spin water, entraining air, and compressing the incoming air.

15) A method of harvesting water from the atmosphere, comprising the steps of: utilizing a centrifuge to spin water, entraining air, compressing the incoming air, releasing the pressurized air-water mixture through thrust nozzles to recover energy lost in spinning the centrifuge.
